(19) United States
(12) Patent Application Publication
(10) Pub. No.: US 2008/0134732 A1
(43) Pub. Date: Jun. 12, 2008

(54) Key Box for Locked Storage of Coded Access Items Such as Access Cards and Keys

(75) Inventor: Eigil Petersen, Greve (DK)

Correspondence Address: JACOBSON HOLMAN PLLC, 400 SEVENTH STREET N.W., SUITE 600, WASHINGTON, DC, 20004, US

(73) Assignee: BIREPO APS, Greve (DK)

(21) Appl. No.: 11/887,636

(22) PCT Filed: Mar. 29, 2006
(86) PCT No.: PCT/DK06/00175

§ 371 Date: Jan. 2, 2008

(30) Foreign Application Priority Data
Mar. 30, 2005 (DK) BA 2005 00078

(51) Int. Cl. E05B 47/00; E05B 19/00; E05B 41/00; E05B 45/06; E05B 47/02; E05G 1/00; E05G 1/10; G07C 9/00

(52) U.S. Cl. 70/63; 340/5.7

(57) ABSTRACT

A key box is provided where, instead of the known mechanical cylinder, an electrically activatable motor is provided for opening and locking the key box. The key box further comprises a signal receiver and a control unit configured for activating the electric motor based on an external signal, and where the control unit is separate from the key box, and being connected to the electric activatable motor via wiring extending through the wall or building part on which the key box is mounted.

### FIELD OF USE OF THE INVENTION

The present invention relates to a key box for being mounted in or on a wall or the like structural part for storing and safeguarding one or more access items, be it access cards or keys, and wherein the key box comprises a box housing and a lid part lockably configured in the box housing, and wherein the box housing and the lid part combine in their closed state to be locked by means of a locking mechanism intended there for, whereby they form a locked, closed space for storing the coded access items, but wherein the lid part may, following release of the locking mechanism, be completely or partially removed from the box housing, whereby access is obtained for taking out the coded access items.

### STATE OF THE ART

Today key boxes of the above-mentioned kind are used for all purposes—ranging from public institutions to private applications. Alarm and security services companies use them to obtain necessary access to locked localities. A key box of this kind is thus used by a coded access item being put in the container part of the key box which is arranged near a door or the like, where the coded access item enables access. Hereby it is possible for eg a watchman or other individual with access to open the key box to access the access item(s) contained in the key box, following which such person can obtain access to open said door or the like. The coded access items in the key box thus being, in many situations, arranged in a spot which may be known to other persons than the ones being authorized to use the coded access items, strict requirements are obviously made to the construction of the box to ensure, to the widest extent possible, that it cannot be opened by someone not authorized to do so.

Therefore such key boxes have been developed which assume a vast number of different configurations; the development of such being aimed primarily at increasing the security against the key box being openable upon mechanical influence by an unauthorized individual simultaneously with the dimensions of the key box being as small as possible to provide a great degree of freedom to arrange it in a wall or other permanent structure.

### The Particular Effect Obtained by the Invention in re the State of the Art

In the light of this it is the object of the present invention to provide a key box giving, compared to the known ones, an enhanced safety against an unauthorised person obtaining access to the coded access items contained in the key box.

This is accomplished in accordance with claim 1 in that the key box is provided with an electric cylinder motor in replacement of the known mechanical lock cylinder, and in that the key box comprises an electronic control unit for activating the electric cylinder motor with a view to opening and locking the key box.

If the electrically activatable cylinder motor comprises an electromotor provided with a gear with exchange reducing the number of revolutions on the output shaft of the gear at least 70 times compared to its input shaft, it is obtained that a very small electromotor can be used and an associated small gear whereby the overall unit can easily be built integrally with a comparatively small key box.

In this context freedom is also provided to construct the lock parts such that they comprise a lock housing for accommodating both the electrically activatable cylinder motor and for displaceably receiving the lock latch; and wherein the lock housing is configured such that, instead of accommodating the electrically activatable cylinder motor, it is possible to accommodate a conventional mechanical lock cylinder for displacing the lock latch. Thereby it is enabled to optionally provide the key box with a conventional mechanical lock cylinder or an electric one in accordance with the present invention, or optionally to upgrade key boxes already mounted featuring a conventional mechanical lock cylinder with an electrically activated version.

Particularly advantageously, at least a part of the electronic control unit is configured as a unit which is separate from the key box; and that wires are configured for transferring power and control signals between the key box and the separate part of the electronic control unit. These wires can thus be conveyed through the wall behind the key box and out on the other side, whereby the separate unit constituting at least a part of the control unit can be arranged in a safe place.

In this context the invention further enables configuration of the electronic control unit with a view to opening of the key box upon receipt from external control signals from known signal emitters, such as the cable, radio, mobile telephone (such as SMS), infrared, Bluetooth, transponder, responder, code keyboard, finger scanner or iris scanner.

Moreover, the key box may conveniently be configured such that an electric switch is provided in the key box, which switch is configured such that it is activated when the lid part of the box housing is closed and hence emits a signal to the electronic control unit to close the key box. Hereby it is ensured that the key box is locked efficiently when the lid part is closed, and hereby safety is obtained against the user of the key box forgetting to close it after the lid part has been closed.

In this context the electronic switch is further advantageously connected to a conventional electronic alarm unit in such a manner that it emits a known sabotage signal if the lid part on the key box is opened. Hereby it is ensured that the user is made aware that he should close the lid part following use.

Moreover the key box may conveniently be provided with an acoustic electronic signal emitter configured such that it emits an acoustic signal when the electrically activatable cylinder motor is activated whereby the user is made aware that the electromotor runs and that he is to act accordingly.

The invention will now be explained in further detail with reference to the drawing, wherein

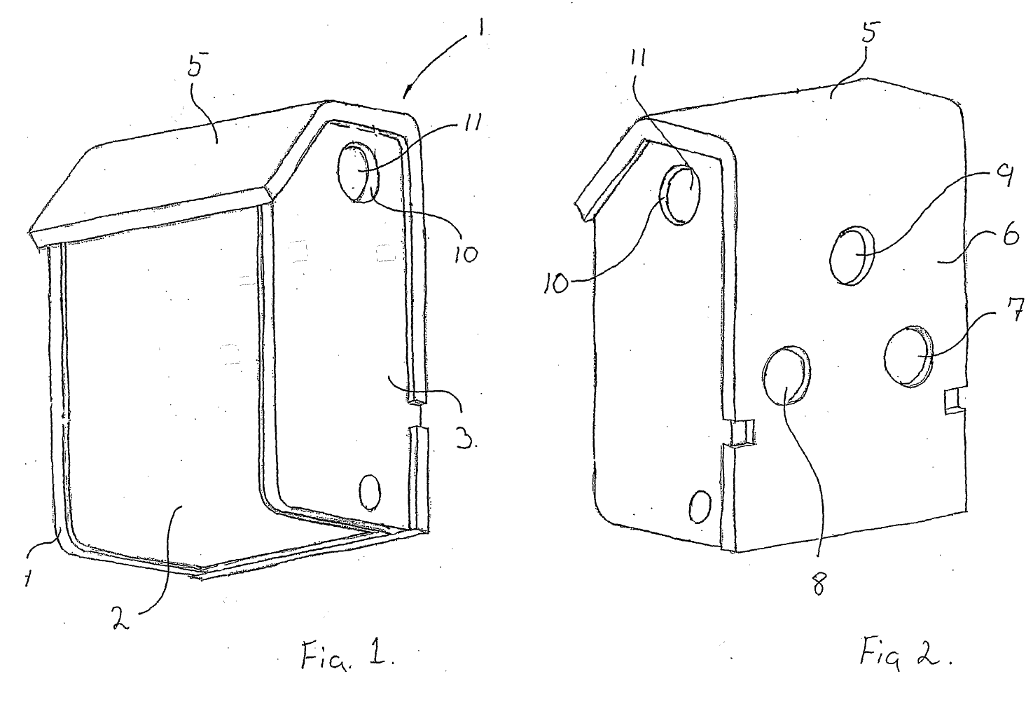

FIG. 1 shows the entire key box according to the invention, seen diagonally from in front;

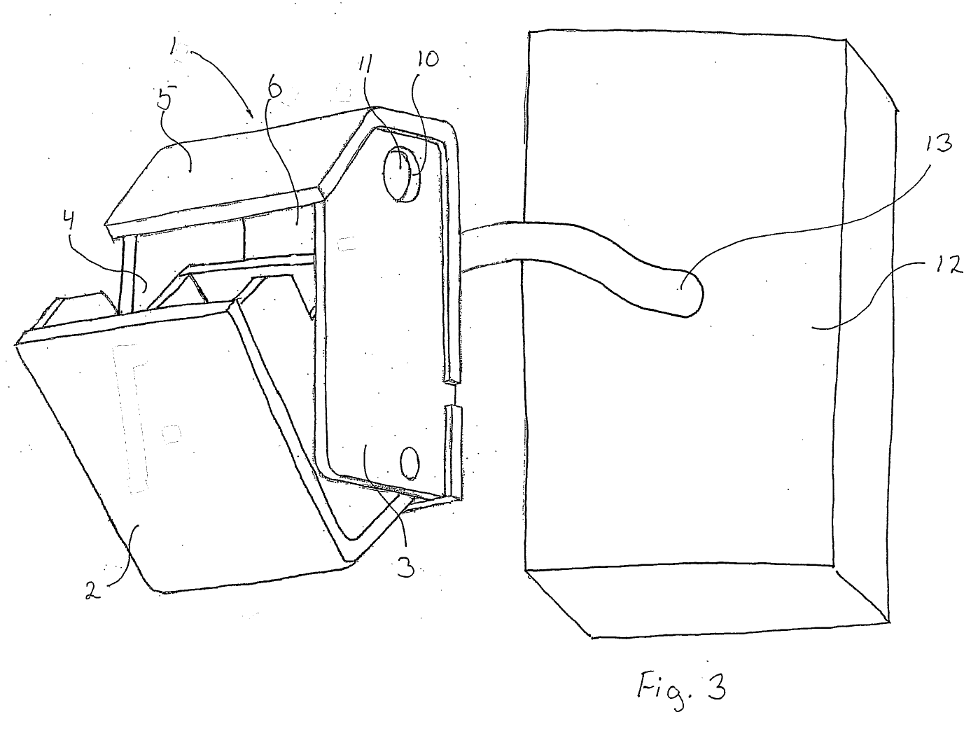

FIG. 2 shows the key box according to FIG. 1, seen diagonally from behind and from the bottom and in closed state;

FIG. 3 shows key box according to the invention seen diagonally from in front and from the bottom, but in open state and in accordance with a further preferred embodiment featuring a separate control unit according to the invention.

Thus, FIGS. 1 and 2 show a key box in accordance with a preferred embodiment of the invention, wherein the key box comprises a box housing 1 and a lid part 2. The box housing 1 is configured with an upper shielding 5 forming a roof on the box when the latter is mounted correctly on an essentially vertical wall or the like. In the same position the box housing 1 further forms two lateral shieldings 3, 4 that shield the closed box to the right and to the left, respectively, and it has a rear plate 6 forming at least a part of the rear side of the box which faces towards the vertical wall.

As will appear, the rear plate of the box housing is configured with two mounting apertures 7, 8 for receiving a mounting bolt or the like attachment means. According to the invention is an option to further provide a separate aperture 9 for passage of electric wires for power supply and signal to the electric units that are, in accordance with the invention, configured in the box. Alternatively it is an option in accordance with a preferred embodiment of the invention to use hollow attachment means, through which said wires can be drawn. By the latter embodiment effective protection of the wires is thus obtained.

Moreover, the one lateral shielding 3 features an aperture 10 for receiving a lock cylinder, which, in the shown embodiment, may be replaced by an electric motor 11, and not shown electronic means for receiving an external signal and based on that activating the electric motor 11 to either open or close the box. Thus, the shown embodiment of the invention is conveniently configured in such a manner that the cylinder is attached to the box housing 1 secured on the wall.

In the embodiment shown in FIG. 1 and 2, the box is configured with said electric motor 11 which, in accordance with the invention, replaces the known mechanical lock cylinder and, in its simplest form, such unit may work by an electric signal receiver being configured in the box housing in addition to the electric motor 11, which electric signal receiver is configured for activating the electric motor 11. In this embodiment a power source may be configured in the box housing 1 as such or power may be supplied through wires that pass through rear of the box housing 1 as described above.

Alternatively the present invention may assume a vast variety of different embodiments in that, as shown in FIG. 3 and instead of integrating the control unit in the box as such as taught in the context of FIGS. 1 and 2, a separate control box 12 is provided, which control box 12 may contain the requisite electronics for activating the electric cylinder motor 11 in the box housing 1 and for establishing eg sabotage alarm and many other features. In this manner it is possible to establish considerably more control electronics whereby it is possible to accomplish many different functions without having to take into consideration that they should be made so compact as to be mountable in the box housing 1. Moreover, it is accomplished that the box housing can effectively be mounted on the outside of a wall while simultaneously the requisite electronic control 12 is arranged interiorly and hence safeguarded against sabotage and unauthorized use, should they occur. By this embodiment it will thus be necessary, as shown in the drawing, to supply both power to the electric cylinder motor 11 and control signals for activation thereof as well as other electronics in the key box via a cable 13.

Irrespective of whether the signal receiver is integral with the box housing 1 or is mounted in a separate control unit 12, it is thus possible to transmit a suitable signal thereto, whereby the control is able to open or lock the box by suitably activating the electric cylinder motor 11; and to this end it is an option to use radio-transmitted or wire-transmitted signals of all known kinds, such as mobile telephone (optionally SMS), infrared, Bluetooth, transponder, responder, code keyboard, finger scanner or iris scanner.

The person skilled in the art is able to configure the electronic control in many different ways, and hence the drawing does not show a specific print configuration and, by the invention, the person skilled in the art may freely chose between different varieties of electric motors to open and close the box; however, the preferred embodiment uses an electric motor with a gear that considerably reduces the number of revolutions of the motor, thereby enabling use of a compact motor and gear unit.

1-8. (canceled)

9. A method of mounting a key box for in or on a wall or the like structural part for storing and safeguarding one or more access items, be it access cards or keys, wherein the key box comprises a box housing (1) having means for being secured in or on a wall or other permanent structure, and a lid part (2) configured in the box housing (1) for storing the access items, and wherein the lid part (2) may be removed completely or partially from the box housing (1) for providing access to a space in the key box in which said access items are arranged; and in that lock parts are configured which are configured in such a manner that the lid part (2) can be secured in a position relative to the box housing (1) by which, in this locked position, the box housing (1) and the lid part (2) form a closed space for the access items, and wherein the lock parts comprise a displaceable latch (3) and means for displacing the lock latch (3) between a first position in which the lid part (2) can be removed entirely or partially from the box housing (1), and a second position in which the lid part (2) is securely locked to the box housing (1), and wherein that the means for displacing the lock latch (3) comprises an electric activatable cylinder motor (4) and an electronic control unit (5) which, based on suitable external control signals, is configured for providing the electrically activatable cylinder motor (4) with power and control signals for controlled displacement of the lock latch (3), characterised in that at least a part of the electronic control unit is configured as a unit which is separate from the key box; and that the box housing (1) is mounted on the outside of a wall and the electronic control unit (5) is arranged interiorly and being connected to the key box via wires that extend through the brickwork or the building part.

10. A key box for mounting in or on a wall or the like structural part for storing and safeguarding one or more access items, be it access cards or keys, wherein the key box comprises a box housing (1) having means for being secured in or on a wall or other permanent structure, and a lid part (2) configured in the box housing (1) for storing the access items, and wherein the lid part (2) may be removed completely or partially from the box housing (1) for providing access to a space in the key box in which said access items are arranged; and in that lock parts are configured which are configured in such a manner that the lid part (2) can be secured in a position relative to the box housing (1) by which, in this locked position, the box housing (1) and the lid part (2) form a closed space for the access items, and wherein the lock parts comprise a displaceable latch (3) and means for displacing the lock latch (3) between a first position in which the lid part (2) can be removed entirely or partially from the box housing (1), and a second position in which the lid part (2) is securely locked to the box housing (1), and wherein that the means for displacing the lock latch (3) comprises an electric activatable cylinder motor (4) and an electronic control unit (5) which, based on suitable external control signals, is configured for providing the electrically activatable cylinder motor (4) with power for displacement of the lock latch (3), characterised in that at least a part of the electronic control unit is configured as a unit which is separate from the key box; and that wires that extend through the brickwork or the building part are configured for transmitting power and control signals between the key box and the separate part of the electronic control unit.

11. A key box according to claim 10, characterised in that the electrically activatable cylinder motor comprises an electromotor provided with a gear with an exchange reducing the number of revolutions on the output shaft of the gear at least 70 times and preferably more than 200 times compared to its input shaft.

12. A key box according to claim 11, characterised in that the lock parts comprise a lock housing for accommodating both the electrically activatable cylinder motor and for displaceably receiving the lock latch; and wherein the lock housing is configured in such a manner that, instead of accommodating the electrically activatable cylinder motor, it is possible to accommodate a conventional mechanical lock cylinder for displacement of the lock latch.

13. A key box according to claim 9, characterised in that the electronic control unit is configured for opening the key box upon receipt of external control signals from known electronic signal emitters, such as cable/wire, radio, mobile telephone (such as SMS), infrared, Bluetooth, transponder, responder, code keyboard, finger scanner or iris scanner.

14. A key box according to claim 10, characterised in that the key box is configured with an electric switch configured such that it is activated upon closing of the lid part in the box housing and thereby emits a signal to the electronic control unit with a view to locking the key box.

15. A key box according to claim 14, characterised in that the electronic switch is further connected to a conventional electronic alarm unit in such a manner that it emits a known sabotage signal if the lid part on the key box is open.

16. A key box according to claim 10, characterised in that the key box is configured with an acoustic electronic signal emitter configured such that it emits an acoustic signal when the electrically activatable cylinder motor is activated.
